(19) United States
(12) Patent Application Publication
(10) Pub. No.: US 2022/0180324 A1
(43) Pub. Date: Jun. 9, 2022

(54) System for Providing Pay Rate Guidance for a Job Position

(71) Applicant: PRO Unlimited Global Solutions, Inc., San Francisco, CA (US)

(72) Inventors: Ted Sergott, Moraga, CA (US); Nataliya Kolb, San Francisco, CA (US); Haihua Huang, Cupertino, CA (US); Dustin Burgess, Folsom, CA (US); Drew Wittig, San Francisco, CA (US); Myra Friel, San Francisco, CA (US)

(21) Appl. No.: 17/114,221

(22) Filed: Dec. 7, 2020

(51) Int. Cl. G06Q 10/10; G06Q 30/02

(52) U.S. Cl. CPC G06Q 10/1053; G06Q 30/0201

(57) ABSTRACT

A system for providing on-demand rate guidance for a job position in at least one geographic location. The system includes a communication device and an automated pay rate creation system installed with a pay rate creation application. A presentation module provides a messaging window on the communication device for the user interactions. A request module provides queries on the messaging window to request job details. A pay rate processing and parsing module receives the job details and processes and parses the job details into user specific configurations and stores in a pay rate database. A pay rate creation module creates the pay rates. A pay rate identification module performs a pay rate analysis and generates a confidence factor on the data quality. A resource hiring module recommends the candidate work location for hiring at least one resource based on the pay rates and the confidence factor.

### BACKGROUND OF THE DISCLOSURE

### Technical Field of the Disclosure

The present invention relates generally to systems for determining location-based salary structures, and more particularly, to a system and method for providing on-demand rate guidance for a job position in at least one geographic location utilizing an automated pay rate creation system.

### DESCRIPTION OF THE RELATED ART

Determining a salary scale is a top concern for potential hires and employers. A fair salary scale attracts and retains top talent in an organization. In order to achieve success and strong company culture, some employers have moved beyond just competitive salaries but also offer expanded compensation packages. It can sometimes be more economical for employers to ensure their compensation packages are in compliance with current industry standards than to spending time and resources recruiting candidates for a job position. There are several factors for determining fair and competitive compensation pay rates. Such factors include but are not limited to the potential employee's years of experience, education level, industry, location, in-demand skill sets and overall market supply and demand for employees. Among these factors, location is one of the primary factors used in benchmarking pay rates. Location based salary structures ensure that jobs are neither over-paid nor under-paid relative to their specific marketplaces, thereby controlling salary expenses. Generally, location-based salary structure is created based on city, state or region and cost of labor. A location-based salary structure confirms that jobs are market priced fairly enough to support a highly motivated workforce.

Various methods have been developed to provide location-based compensation. One such method describes an improved system and method for facilitating placement of candidates between employers and recruiters. This system includes an integrated interface within an applicant tracking system (ATS) platform for employers and integrated interface within the talent platforms for recruiters. A talent platform exchange for managing hiring process exhibits data processing activities including filtering job orders based on information related to a particular staffing party, geographical information, job order information, as well as other information. The talent platform exchange engine filters job orders thereby creating a subset of job orders with data fields associated with geographical location that matches with a candidate job location. However, this system is not designed to search job openings for various levels of a particular job position. The database integrated into this placement facilitating system is not capable of storing an ample amount of market data thereby narrowing the job search results. Also, the database is not designed to perform a global pay rate search.

Therefore, there is a need for an efficient and reliable system for performing a location-based pay rate search. Furthermore, such a system would possess a database capable of storing a large volume of data including market and client data thereby improving the overall quality of location-based pay rate search. Such a system would be designed to provide pay rate data on job openings for various levels of a job position. Moreover, such a system would allow the user to perform domestic and international pay rate searches. Such a system would provide pay rate data based on candidate skills and experience levels. Further, such a system would recommend a job location for hiring a resource based on cost and value. Such a system would request data to the user in a user-friendly manner. The present embodiment overcomes shortcomings in the field by accomplishing these critical objectives.

### SUMMARY OF THE INVENTION

To minimize the limitations found in the prior art, and to minimize other limitations that will be apparent upon the reading of the specification, the present disclosure provides a system for providing on-demand rate guidance for a job position in at least one geographic location. The system includes at least one communication device and an automated pay rate creation system. The at least one communication device is configured to allow a user to provide a plurality of job details including the job position and a candidate work location. The automated pay rate creation system is in communication with the at least one communication device via a network. The automated pay rate creation system includes a processor installed with a pay rate creation application and provides a plurality of pay rates to the user based on the job position and the candidate work location.

The automated pay rate creation system includes a presentation module, a database module, a global search module, a request module, a pay rate processing and parsing module, a pay rate creation module, a pay rate identification module and a resource hiring module. The presentation module is designed to present a messaging window on the at least one communication device for interacting with a user. The presentation module is designed to to display a plurality of resource levels and the plurality of pay rates on a single web page in the messaging window of the communication device thereby providing a consolidated view of the plurality of job details to the user. The presentation module displays a plurality of client locations for the requested job position in the messaging window.

The database module stores market data and client specific data. Furthermore, database module stores details of the plurality of resource levels corresponding to the job position in a pay rate database. For example, if the job position is ‘Software Engineer’ then the database module stores details of different levels of software engineer such as junior level, middle level, senior level and principal level in the pay rate database. The pay rate database provides data on pay roll rates, markups and fees. The global search module is configured to enable the user to perform a worldwide pay rate search to obtain the plurality of pay rates for the job position. The request module provides a plurality of queries on the messaging window in a user-friendly manner to request the plurality of job details. The pay rate processing and parsing module receives the plurality of job details from the request module and processes and parses the plurality of job details into user specific configurations and stores in the pay rate database. The pay rate creation module creates the plurality of pay rates including an average pay rate once the user confirms the plurality of job details utilizing the pay rate creation application. The pay rate identification module is configured to identify the market rate and the pay rate algorithmically for each of the plurality of job details provided by the user. The pay rate identification module allows the system to perform a pay rate analysis and to generate a confidence factor on the data quality based on the job position and the candidate work location. The resource hiring module is configured to recommend the candidate work location for hiring at least one resource based on the plurality of pay rates and the confidence factor. The resource hiring module recommends the candidate work location based on cost and value. Preferably, the candidate work location may be an existing location or a new location. The resource hiring module provides data regarding the availability of the at least one resource such as candidate availability and hiring difficulty at the recommended work location. Further, the resource hiring module provides data on the elasticity of price versus quantity and quality of the resource. Moreover, the resource hiring module provides data regarding time taken for hiring a candidate (Time to fill). The preferred embodiment provides data on skill requirements affecting market rates. If the user adds or subtracts a specific skill, the pay rates could be changed. The automated pay rate creation system enables the user to obtain details of a plurality of rate types for the job position. The plurality of rate types includes staffing, payroll and worker pay rate.

The at least one communication device is selected from a group consisting of: a cellular telephone, a smartphone, a wireless-enabled personal digital assistant, a tablet, a personal computer, a notebook, a mobile device, or any device allowing access to a network and interaction with a user. The network is preferably a data communication network selected from a group consisting of: Internet, a local area network (LAN), a wide area network (WAN), wired Ethernet, wireless Ethernet and cellular wireless network.

The preferred embodiment includes a method for providing on-demand rate guidance for the job position in the at least one geographic location utilizing the automated pay rate creation system. The method is initiated by providing the automated pay rate creation system. Next, the pay rate creation application is installed in the automated pay rate creation system. Then, the messaging window is provided on the at least one communication device for user interactions by a presentation module. Thereafter, the market data, client specific data and details of the plurality of job levels corresponding to the job position are stored in the pay rate database. The user then performs the worldwide pay rate search to obtain the plurality of pay rates for the job position by the global search module. Upon performing the pay rate search, the plurality of queries is provided on the messaging window in a user-friendly manner to request the plurality of job details by the request module. The plurality of job details is received from the request module and the job details are processed and parsed into user specific configurations by the pay rate processing and parsing module. Thereafter, the processed and parsed job details are stored in the pay rate database. The plurality of pay rates are created once the user confirms the plurality of job details through the pay rate creation module. The market rate and the pay rate are identified algorithmically for each of the plurality of job details by the pay rate identification module. The pay rate analysis is performed and the confidence factor on the data quality is generated based on the job position and the candidate work location by the pay rate identification module. Finally, the resource hiring module recommends the candidate work location for hiring at least one resource based on the plurality of pay rates and the confidence factor.

It is a first objective of the present invention to provide an efficient and reliable automated pay rate creation system that performs a location-based pay rate search.

A second objective of the present invention is to provide an automated pay rate creation system that possesses a database capable of storing a large volume of data including market and client data thereby improving the overall quality of location-based pay rate search.

A third objective of the present invention is to provide an automated pay rate creation system that provides pay rate data on job openings for various levels of a job position.

A fourth objective of the present invention is to provide an automated pay rate creation system that allows the user to perform domestic and international pay rate searches.

A fifth objective of the present invention is to provide an automated pay rate creation system that provides pay rate data based on candidate skills and experience levels.

Another objective of the present invention is to provide an automated pay rate creation system that recommends job location for hiring a resource based on cost and value.

Yet another objective of the present invention is to provide an automated pay rate creation system that requests data to the user in a user-friendly manner.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention. Thus, the drawings are generalized in form in the interest of clarity and conciseness.

FIG. 1 illustrates a block diagram of a system for providing on-demand rate guidance for a job position in accordance with the preferred embodiment of the present invention;

FIG. 2 illustrates a flowchart of a method for providing on-demand rate guidance for the job position in at least one geographic location utilizing an automated pay rate creation system in accordance with the preferred embodiment of the present invention;

FIG. 3 is a screenshot of a messaging window for selecting a domestic pay rate search and an international pay rate search utilizing a global search module in the automated pay rate creation system in accordance with the preferred embodiment of the present invention;

FIG. 4 is a screenshot of a messaging window for receiving a plurality of job details from a user in accordance with the preferred embodiment of the present invention;

FIG. 5 is a screenshot of a messaging window for displaying a plurality of pay rates of staffing type based on the plurality of job details provided by the user in accordance with the preferred embodiment of the present invention;

FIG. 6 is a screenshot of a messaging window which illustrates a graphical representation of the plurality of pay rates against years of work experiences in accordance with the preferred embodiment of the present invention;

FIG. 7 is a screenshot of a messaging window which illustrates a graphical representation of a comparison between a plurality of rate types in accordance with the preferred embodiment of the present invention;

FIG. 8 is a screenshot of a messaging window which illustrates a graphical representation of a comparison between the plurality of pay rates at a particular location and the plurality of pay rates based on current market rate in accordance with the preferred embodiment of the present invention;

FIG. 9A is a screenshot illustrating a percentage of pay difference by location in accordance with the preferred embodiment of the present invention;

FIG. 9B is a screenshot illustrating the percentage of pay difference by location on a map in accordance with the preferred embodiment of the present invention;

FIG. 10A is a screenshot of a messaging window which illustrates skills driving premiums in rates in accordance with the preferred embodiment of the present invention;

FIG. 10B is a screenshot illustrating a graphical representation of average pay rate trends in accordance with the preferred embodiment of the present invention;

FIG. 11 is a screenshot of a messaging window for displaying the plurality of pay rates under payroll category based on the plurality of job details provided by the user in accordance with the preferred embodiment of the present invention;

FIG. 12 is a screenshot of a messaging window for displaying the plurality of pay rates under worker pay rate category based on the plurality of job details provided by the user in accordance with the preferred embodiment of the present invention;

FIG. 13 is a screenshot of a messaging window for displaying the plurality of pay rates at three different geographic locations in accordance with the preferred embodiment of the present invention;

FIG. 14 is a screenshot of a messaging window which illustrates a graphical representation of a comparison between the plurality of pay rates at the three different geographic locations shown in FIG. 13 in accordance with the preferred embodiment of the present invention;

FIG. 15 is a screenshot of a messaging window which illustrates the plurality of pay rates, details regarding availability of candidates at a job location and time required to hire a candidate at the job location in accordance with the preferred embodiment of the present invention; and

FIG. 16 is a screenshot of a messaging window for displaying the plurality of pay rates of staffing type based on the international pay rate search by the user in accordance with the preferred embodiment of the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

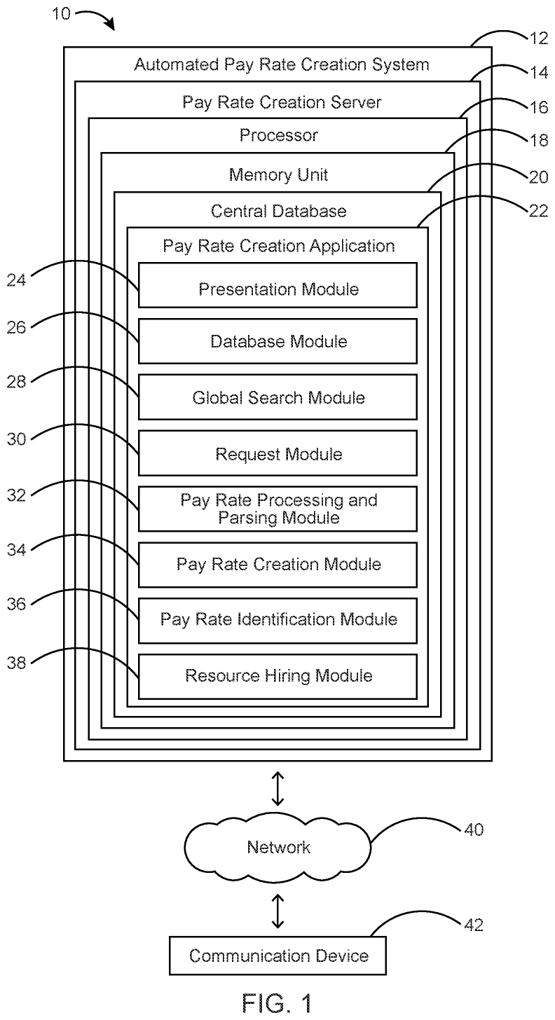

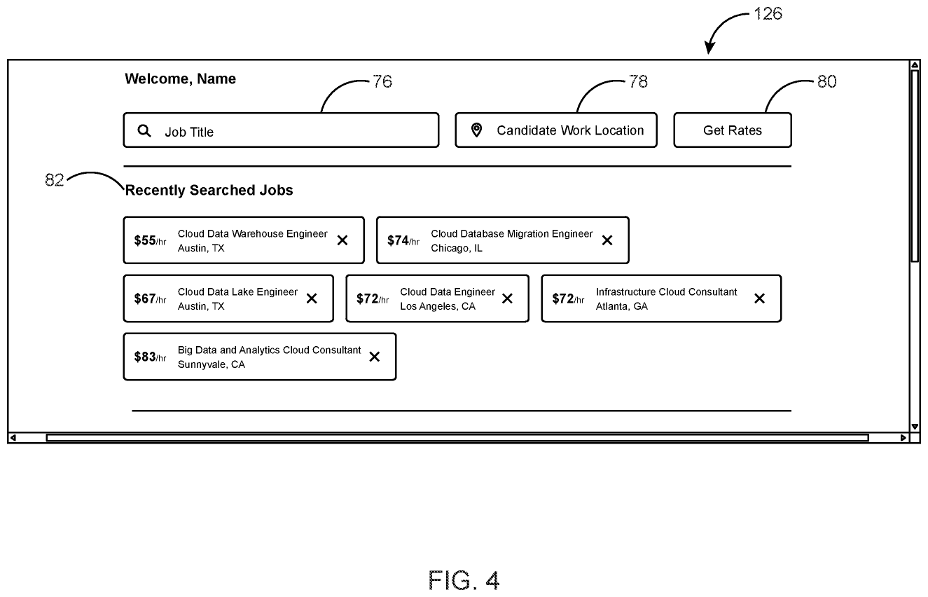

Referring to FIG. 1, a system 10 for providing on-demand rate guidance for a job position 76 (FIG. 4) in at least one geographic location is illustrated. The system 10 includes at least one communication device 42 and an automated pay rate creation system 12. The at least one communication device 42 is configured to allow a user to provide a plurality of job details including the job position 76 and candidate work location 78 (FIG. 4). The automated pay rate creation system 12 is in communication with the at least one communication device 42 via a network 40. The automated pay rate creation system 12 includes a pay rate creation server 14 residing on a central computer having a processor 16 installed thereon with a pay rate creation application 22 and coupled with a memory unit 18 integrated with a central database 20. The automated pay rate creation system 12 provides a plurality of pay rates to the user based on the job position 76 and the candidate work location 78.

As shown in FIG. 1, the automated pay rate creation system 12 includes a presentation module 24, a database module 26, a global search module 28, a request module 30, a pay rate processing and parsing module 32, a pay rate creation module 34, a pay rate identification module 36 and a resource hiring module 38. The presentation module 24 is designed to present with a messaging window 126 on the at least one communication device 42 for user interactions. The presentation module 24 is designed to display a plurality of resource levels and the plurality of pay rates on a single web page in the messaging window 126 of the communication device 42 thereby providing a consolidated view of the plurality of job details to the user. The presentation module 24 displays a plurality of client locations for the requested job position 76 in the messaging window 126. In the preferred embodiment, the pay rate creation application 22 enables the presentation module 24 to display maximum of ten client locations.

The database module 26 stores market data and client specific data. In one embodiment, the client specific data is defined by rate cards. Also, the database module 26 is configured to store details of the plurality of resource levels corresponding to the job position 76 in a pay rate database. For example, if the job position 76 is ‘Software Engineer’ then the database module 26 stores details of different levels of software engineer such as junior level, middle level, senior level and principal level in the pay rate database. The pay rate database provides data on pay roll rates, markups and fees. The global search module 28 is configured to enable the user to perform a worldwide pay rate search to obtain the plurality of pay rates for the job position 76. The request module 30 provides a plurality of queries on the messaging window 126 in a user-friendly manner to request the plurality of job details. The pay rate processing and parsing module 32 receives the plurality of job details from the request module 30 and processes and parses the plurality of job details into user specific configurations and stores in the pay rate database. The pay rate creation module 34 creates the plurality of pay rates including an average pay rate once the user confirms the plurality of job details utilizing the pay rate creation application 22. The pay rate identification module 36 is configured to identify the market rate and the pay rate algorithmically for each of the plurality of job details provided by the user. The pay rate identification module 36 allows to perform a pay rate analysis and to generate a confidence factor on the data quality based on the job position 76 and the candidate work location 78. The resource hiring module 38 is configured to recommend the candidate work location 78 for hiring at least one resource based on the plurality of pay rates and the confidence factor. The resource hiring module 38 recommends the candidate work location 78 for the at least one resource based on cost and value. Preferably, the candidate work location 78 may be an existing location or any new location. The resource hiring module 38 provides data regarding the availability of the at least one resource at the recommended work location. Further, the resource hiring module 38 provides data on the elasticity of price versus quantity and quality of the resource. To be clearer, if the candidate is paid more, the number of candidates and/or the quality of candidates will be increased. Moreover, the resource hiring module 38 provides data regarding the time taken for hiring a candidate (Time to fill). The preferred embodiment provides data on skill requirements affecting market rates. If the user adds or subtracts a specific skill, then the pay rates could be changed.

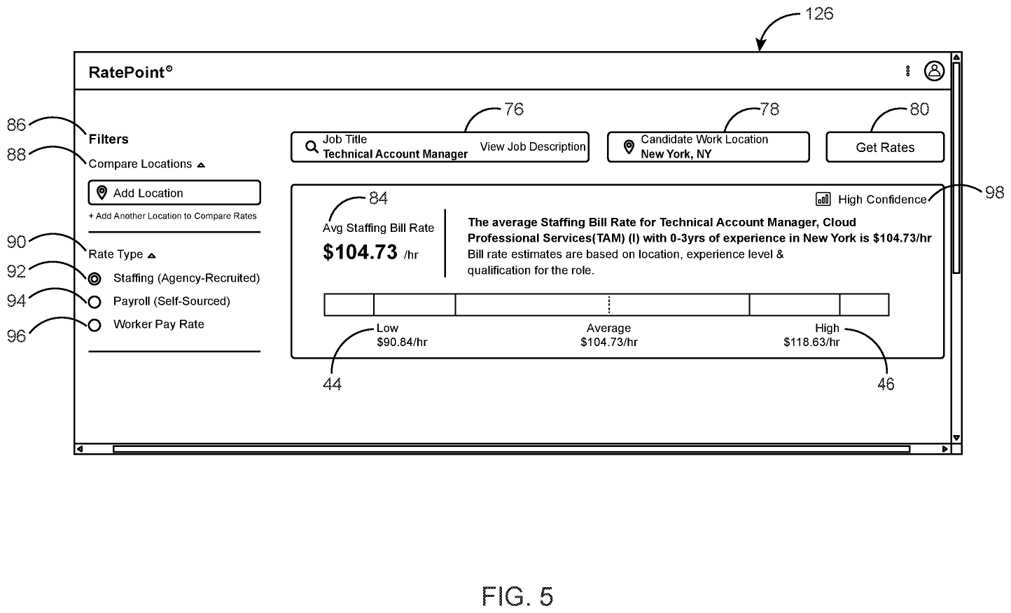

The automated pay rate creation system 12 enables the user to obtain details of a plurality of rate types 90 for the job position 76. The plurality of rate types 90 includes staffing 92 (FIG. 5), payroll 94 and worker pay rate 96. Preferably, the staffing type 92 is agency recruited and the payroll type 94 is self-sourced.

In the preferred embodiment, the at least one communication device 42 is selected from a group consisting of: a cellular telephone, a smartphone, a wireless-enabled personal digital assistant, a tablet, a personal computer, a notebook and a mobile device. The network 40 is a data communication network selected from a group consisting of: Internet, a local area network (LAN), a wide area network (WAN), wired Ethernet, wireless Ethernet and cellular wireless network.

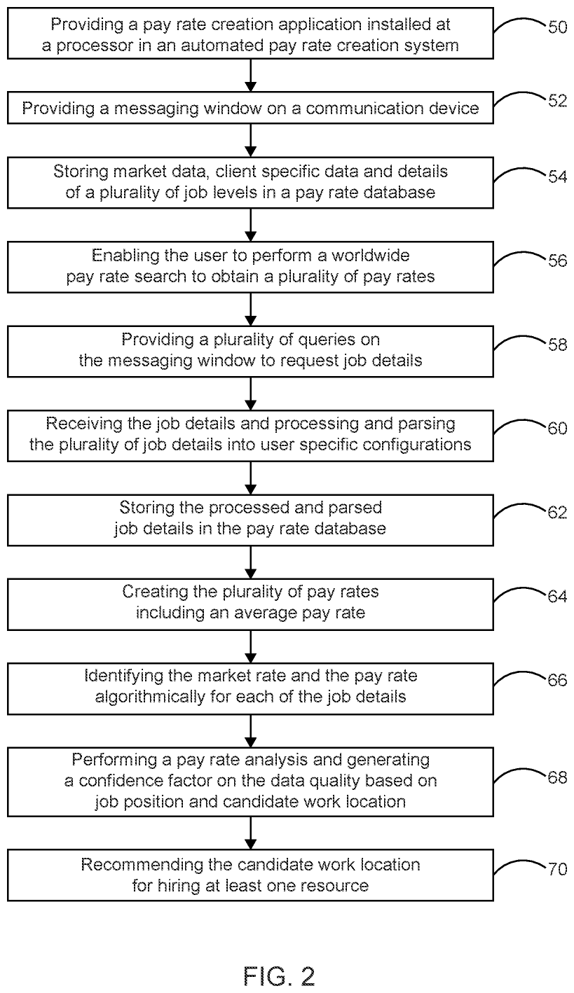

FIG. 2 shows a flowchart of a method for providing on-demand rate guidance for the job position 76 in the at least one geographic location utilizing the automated pay rate creation system 12. The method commences by providing the automated pay rate creation system as shown in block 50. The pay rate creation application is then installed in the automated pay rate creation system. Next, the messaging window is provided on the at least one communication device for the user interactions by a presentation module as indicated at block 52. Thereafter, the market data, client specific data and details of the plurality of job levels corresponding to the job position are stored in the pay rate database as shown at block 54. The user then performs the worldwide pay rate search to obtain the plurality of pay rates for the job position by the global search module as indicated at block 56. Upon performing the pay rate search, the plurality of queries is provided on the messaging window in a user-friendly manner to request the plurality of job details by the request module as shown at block 58. The plurality of job details is received from the request module and the job details are processed and parsed into user specific configurations by the pay rate processing and parsing module as indicated at block 60. Thereafter, the processed and parsed job details are stored in the pay rate database as indicated at block 62. The plurality of pay rates are created once the user confirms the plurality of job details through the pay rate creation module as shown at block 64. The market rate and the pay rate are identified algorithmically for each of the plurality of job details by the pay rate identification module as shown at block 66. The pay rate analysis is performed and the confidence factor on the data quality is generated based on the job position and the candidate work location by the pay rate identification module as indicated at block 68. Finally, the resource hiring module recommends the candidate work location for hiring at least one resource based on the plurality of pay rates and the confidence factor as indicated at block 70.

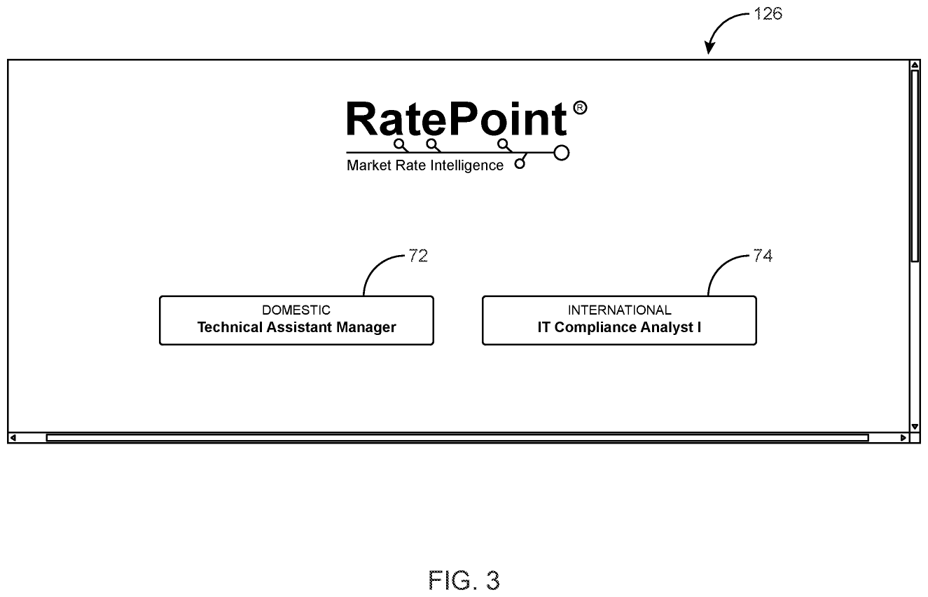

FIG. 3 is a screenshot of a messaging window 126 which illustrates an example for selecting a domestic pay rate search and an international pay rate search. In this example, the user clicks the button ‘Domestic’ 72 to perform the domestic pay rate search for the job position ‘Technical Assistant Manager’. If the user desires to perform the international pay rate search for the job position ‘IT Compliance Analyst I’ then the user clicks the button International' 74.

FIG. 4 is a screenshot of a messaging window 126 which illustrates an example for receiving the plurality of job details from the user. In this web page, the user enters the job title 76 and the candidate work location 78 for getting the plurality of pay rates. The user can view a list of recently searched jobs 82 in this webpage.

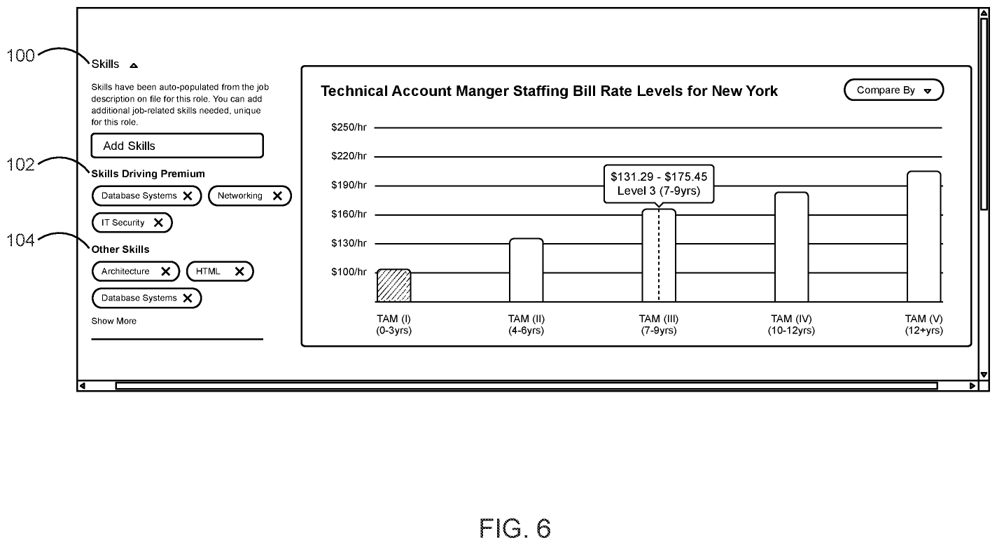

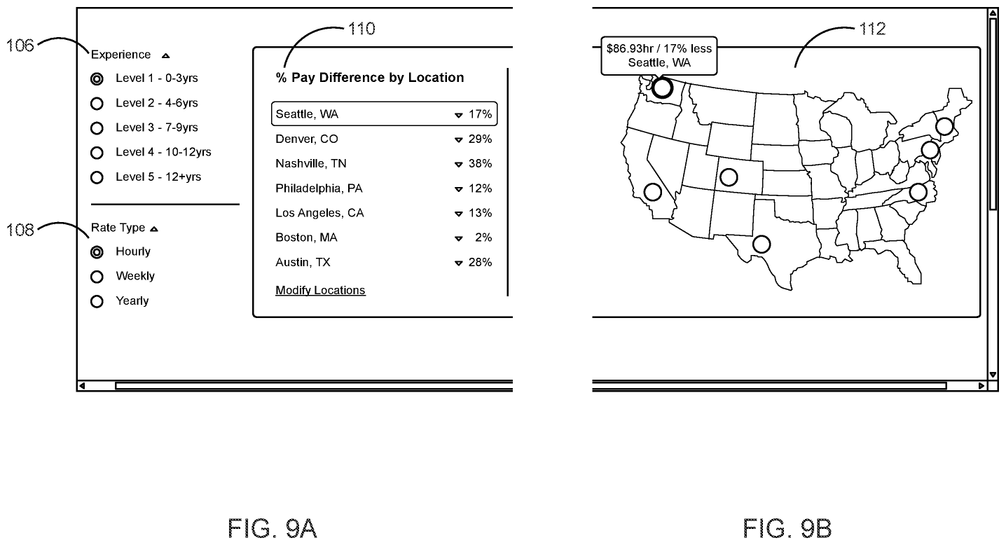

FIG. 5 is a screenshot of a messaging window 126 which illustrates an example for displaying the plurality of pay rates of staffing type 92 based on the plurality of job details provided by the user. The user has provided ‘Technical Account Manager’ as the job title 76 and ‘New York’ as the candidate work location 78. When the ‘Get Rate’ button 80 is clicked, the plurality of pay rates including an average staffing pay rate/bill rate 84, a low pay rate 44 and a high pay rate 46 are displayed. The plurality of pay rates is estimated based on location, experience and qualification for the role. In the preferred embodiment, the pay rates can be filtered utilizing an option ‘Filters’ 86. Preferably, the filters 86 include compare location 88, the plurality of rate types 90, skills 100 (FIG. 6) and experience 106 (FIG. 9A). In this example as shown in FIG. 5, the average staffing pay rate 84 for ‘Technical Account Manager’ with 0-3 years of experience in New York is $104.73/hr.

FIG. 6 is a screenshot of a messaging window 126 which illustrates a graphical representation of the plurality of pay rates against years of work experience based on the example described in FIG. 5. It is clear from the graph that the candidate having more years of experience has a higher pay rate, for instance. The webpage displays options such as skills driving premium 102 and other skills 104 for filtering the plurality of pay rates. When one of the skills 100 is removed then the pay rate drops to a particular value. The user is allowed to add additional job-related skills which are unique for the job title 76 ‘Technical Account Manager’.

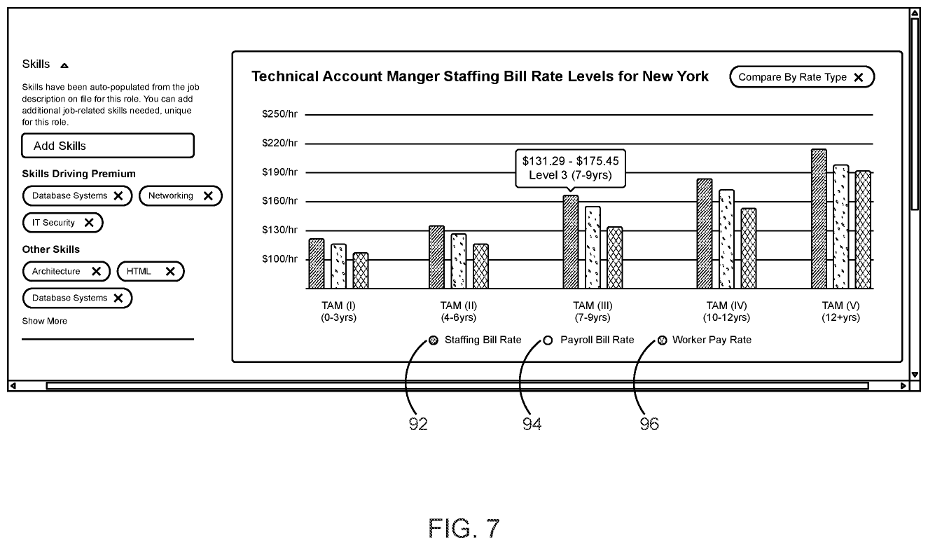

FIG. 7 is a screenshot of a messaging window 126 which illustrates a graphical representation of the plurality of pay rates against the plurality of rate types 90 including staffing pay rate 92, payroll 94 and worker pay rate 96. The graph shows that the average pay rate ranges from $131.29 -$175.45 for a candidate having 7-9 years of experience.

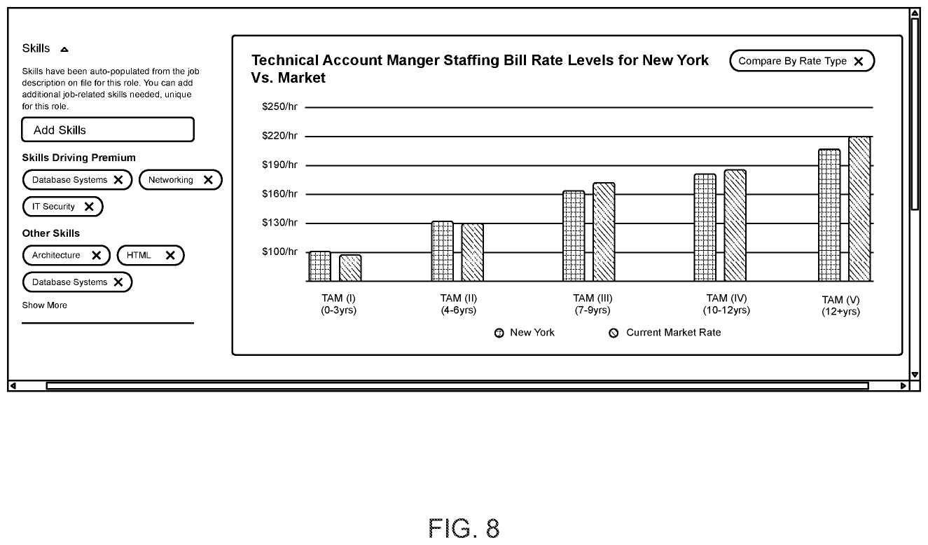

FIG. 8 is a screenshot of a messaging window 126 which illustrates a graphical representation of a comparison between the staffing pay rate 92 for ‘Technical Account Manager’ at New York and the pay rates based on current market rates.

FIG. 9A is a screenshot illustrating a percentage of pay difference by location 110. FIG. 9B is a screenshot illustrating the percentage of pay difference by location 110 on a map 112. According to the map 112, the location Seattle has a pay rate of $86.93 with 17% pay difference. Here, the user has selected the filtering option ‘Experience’ 106 as level 1 with 0-3 years of experience. Also, the user has selected an hourly pay rate difference under the category ‘time-based rate type’ 108.

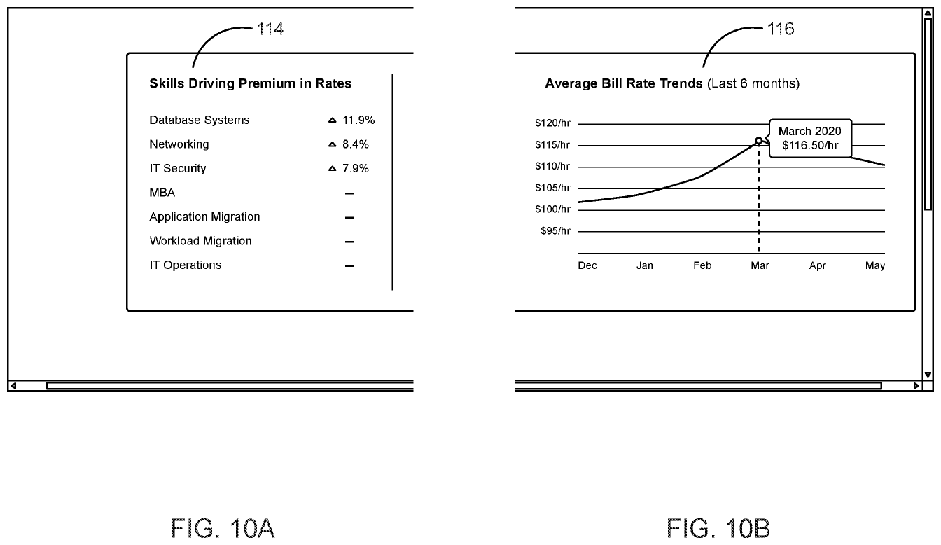

FIG. 10A is a screenshot illustrating skills driving premium in rates 114. FIG. 10B is a screenshot illustrating a graphical representation of an average pay rate trends 116. The graph shows that during the month of March 2020, the average pay rate has attained its peak value of $116-50/hr.

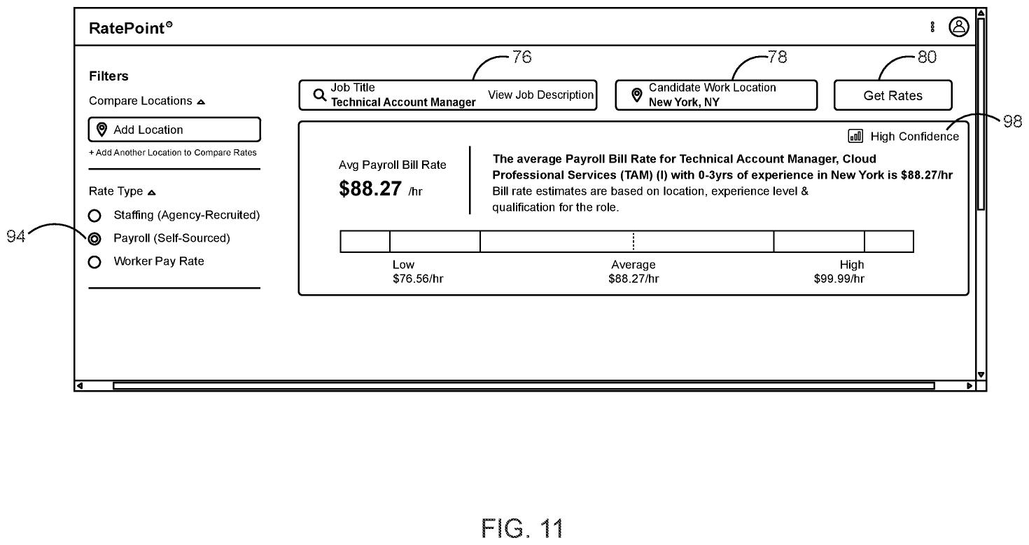

FIG. 11 is a screenshot of a messaging window 126 illustrating the plurality of pay rates of payroll category 94. The pay rates are generated based on the plurality of job details provided by the user. The user has provided ‘Technical Account Manager’ as the job title 76 and ‘New York’ as the candidate work location 78. When the ‘Get Rate’ button 80 is activated, the plurality of pay rates including an average pay roll type pay rate, a low pay rate and a high pay rate are displayed. The plurality of pay rates is estimated based on location, experience and qualification for the role. The average pay rate of pay roll category for ‘Technical Account Manager’ with 0-3 years of experience in New York is $88.27/hr.

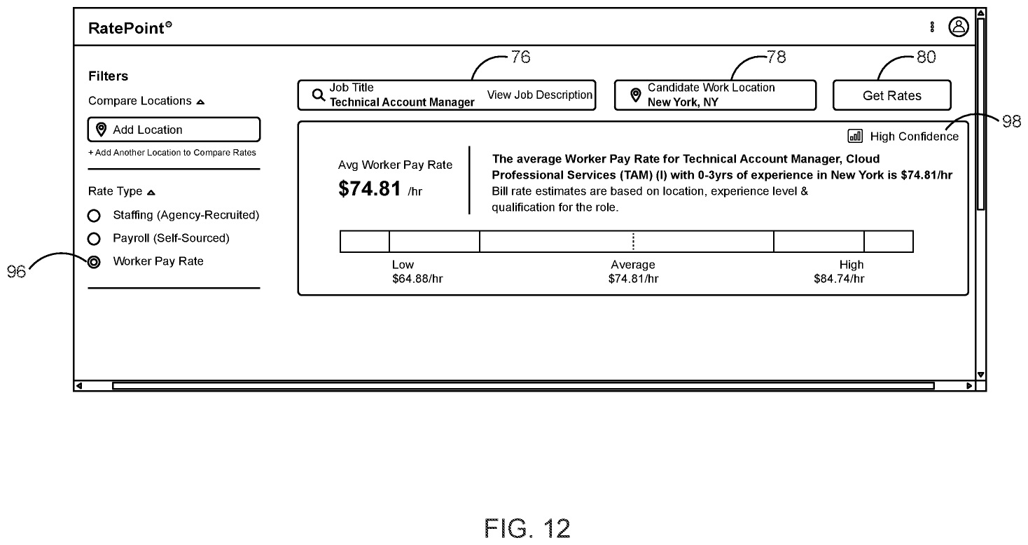

FIG. 12 is a screenshot of a messaging window 126 displaying the plurality of pay rates of worker type category 96. The user has provided ‘Technical Account Manager’ as the job title 76 and ‘New York’ as the candidate work location 78. When the ‘Get Rate’ button 80 is activated, the plurality of pay rates including an average worker pay rate, a low pay rate and a high pay rate are displayed. The average worker pay rate for ‘Technical Account Manager’ with 0-3 years of experience in New York is $74.81/hr.

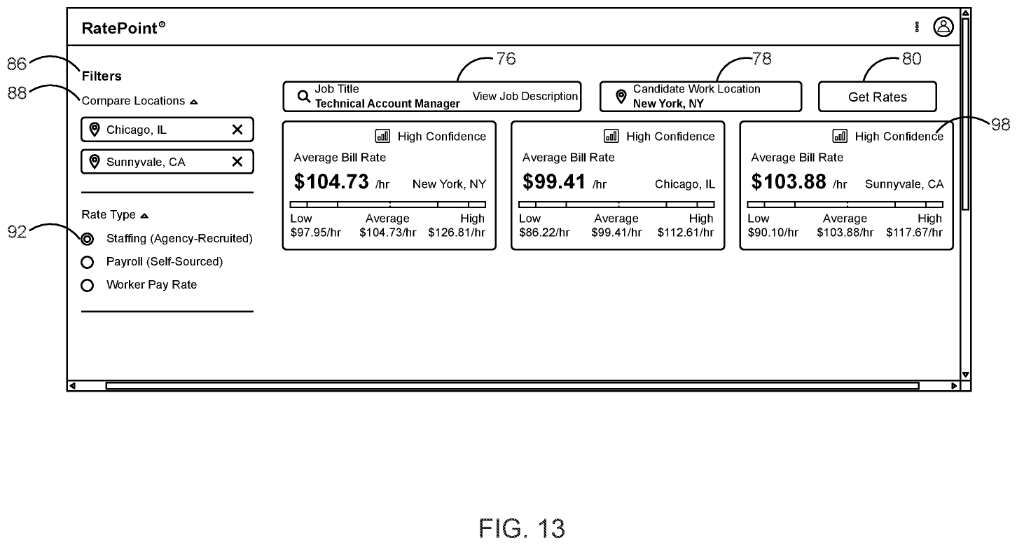

FIG. 13 is a screenshot of a messaging window 126 for displaying the plurality of pay rates at three different geographic locations: New York, Chicago and Sunnyvale. Here, the pay rates are of staffing category 92. The pay rates at these three locations are compared utilizing the ‘compare location’ 88 option.

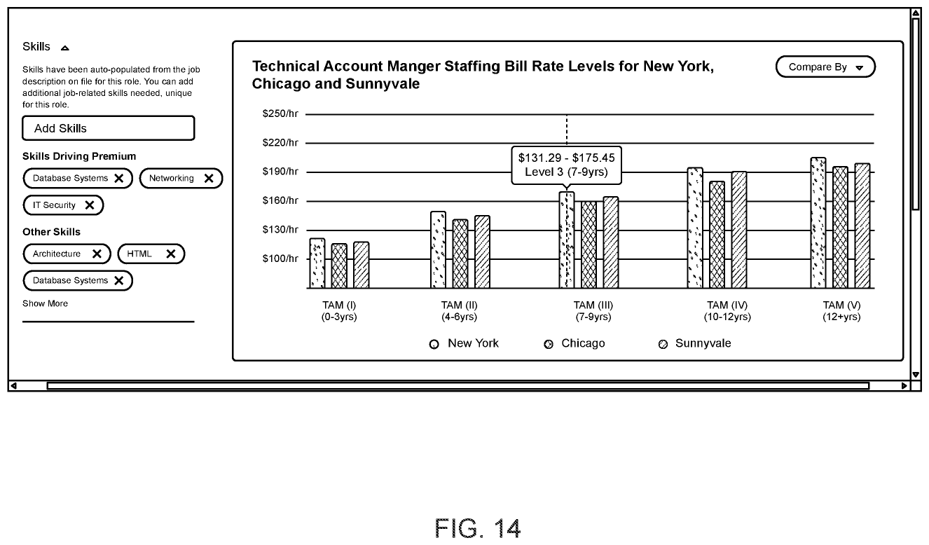

FIG. 14 is a screenshot of a messaging window 126 which illustrates a graphical representation of a comparison between the plurality of pay rates of staffing type 92 at New York, Chicago and Sunnyvale. The graph shows that the average pay rate at these three locations ranges from $131.29 -$175.45 for a candidate having 7-9 years of experience.

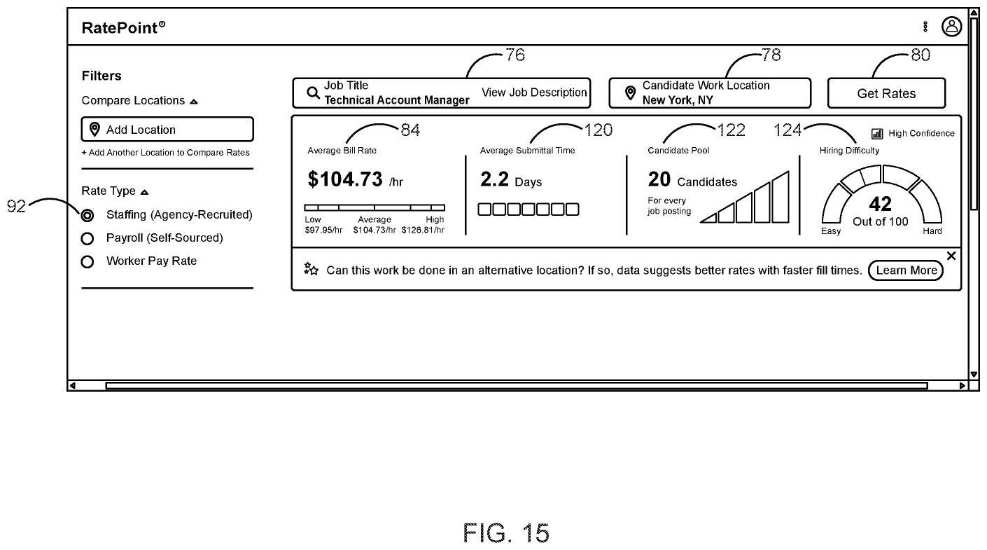

FIG. 15 is a screenshot of a messaging window 126 which illustrates the plurality of pay rates, details regarding availability of candidates at the job location and time required to hire the candidate at the job location. In this example, the average pay rate 84 is $104.73/Hr. and average submittal time 120 is 2.2 days. The automated pay rate creation system 12 provides data on the availability of resources such as candidate availability and hiring difficulty 124 in an area. In this example, a candidate pool 122 with 20 candidates is listed for every job posting. And the hiring difficulty 124 was 42 out of 100.

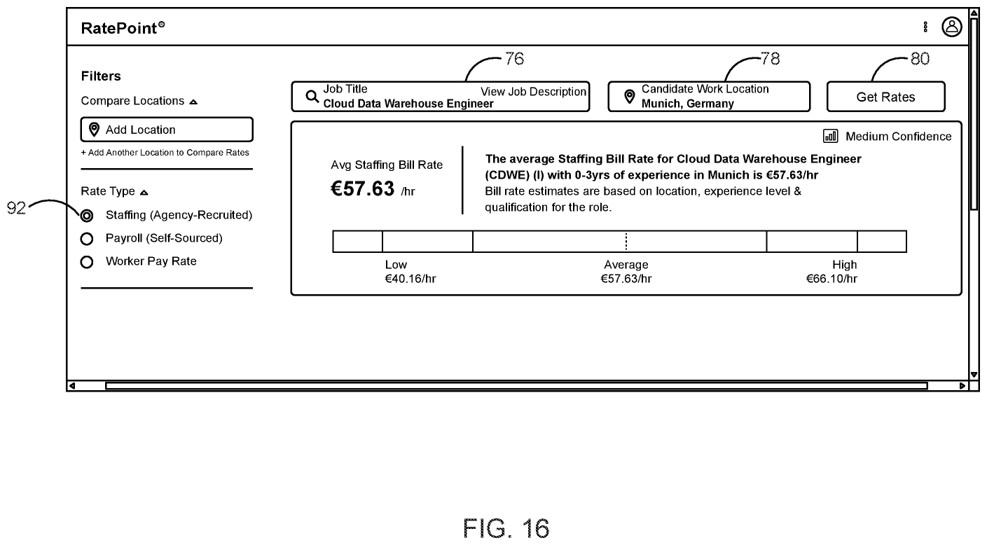

FIG. 16 is a screenshot of a messaging window 126 for displaying the plurality of pay rates of staffing type 92 based on the international pay rate search by the user. In this example, the user has provided ‘Cloud Data Warehouse Engineer’ as the job title 76 and ‘Munich, Germany’ as the candidate work location 78. When the ‘Get Rate’ button 80 is activated, the plurality of pay rates including an average staffing pay rate, a low pay rate and a high pay rate are displayed. The average staffing pay rate for ‘Cloud Data Warehouse Engineer’ with 0-3 years of experience in Munich is €57.63/Hr. with medium confidence factor.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, processor cache, etc., and transmission media such as wires that constitute a system bus coupled to the processor, except for a transitory, propagating signal. The computer program product disclosed herein comprises one or more computer program codes for automating the request creation utilizing the automated pay rate creation system 12.

The medium can be an electronic, magnetic, optical, electromagnetic, infrared, or semiconductor system (or apparatus or device) or a propagation medium. Examples of a computer-readable medium comprise a semiconductor or solid-state memory, a removable computer storage module, a random access memory (RAM), a read-only memory (ROM), a rigid magnetic disk and an optical disk. Input/output or I/O devices (including but not limited to keyboards, displays, pointing devices, etc.) can be coupled to the system 10 either directly or through intervening I/O controllers.

Network adapters may also be coupled to the system 10 to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World

Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet can include a plurality of local area networks (“LANs”) and a wide area network (“WAN”) that are interconnected by routers used to interface one LAN or WAN to another.

Furthermore, computers and other related electronic devices can be remotely connected to either the LANs or the WAN via a digital communications device, modem and temporary telephone, or a wireless link. It will be appreciated that the internet comprises a vast number of such interconnected networks, computers, and routers.

The Internet has recently seen explosive growth by virtue of its ability to link computers located throughout the world. It will be appreciated that the present application 22 could apply in any such interactive communication environments, however, for purposes of discussion, the Web is used as an exemplary interactive hypertext environment with regard to the present pay rate creation application 22.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention to not be limited by this detailed description, but by the claims and the equivalents to the claims appended hereto.

What is claimed is:

1. A system for providing on-demand rate guidance for a job position in at least one geographic location, the system comprising:
at least one communication device configured to allow a user to provide a plurality of job details including job position and candidate work location; and
an automated pay rate creation system being in communication with the at least one communication device via a network, the automated pay rate creation system including a pay rate creation server residing on a central computer having a processor installed with a pay rate creation application and coupled with a memory unit integrated with a central database, the automated pay rate creation system being designed to provide a plurality of pay rates to the user based on the job position and the candidate work location, the automated pay rate creation system comprising:
a presentation module configured to present a messaging window on the at least one communication device for user interactions;
a database module configured to store market data, client specific data and details of a plurality of job levels corresponding to the job position in a pay rate database;
a global search module configured to enable the user to perform a worldwide pay rate search to obtain the plurality of pay rates for the job position;
a request module configured to provide a plurality of queries on the messaging window in a user-friendly manner, the queries requesting the plurality of job details;
a pay rate processing and parsing module configured to receive the plurality of job details from the request module and to process and parse the plurality of job details into user specific configurations and to store in the pay rate database;
a pay rate creation module configured to create the plurality of pay rates including an average pay rate once the user confirms the plurality of job details;
a pay rate identification module configured to identify the market rate and the pay rate algorithmically for each of the plurality of job details provided by the user, the pay rate identification module performing a pay rate analysis and generating a confidence factor on the data quality based on the job position and the candidate work location; and
a resource hiring module configured to recommend the candidate work location for hiring at least one resource based on the plurality of pay rates and the confidence factor;
whereby the pay rate creation module and the pay rate identification module enable the user to select at least one pay rate for the job position.

2. The system of claim 1 wherein the pay rate database provides data on pay roll rates, markups and fees.

3. The system of claim 1 wherein the presentation module is designed to display the plurality of resource levels and the plurality of pay rates on a single web page in the messaging window of the at least one communication device thereby providing a consolidated view of the plurality of job details.

4. The system of claim 1 wherein the presentation module displays a plurality of client locations for the requested job position.

5. The system of claim 1 wherein the pay rate creation module enables the user to obtain details of a plurality of rate types for the job position.

6. The system of claim 5 wherein the plurality of rate types includes staffing, payroll and worker pay rate.

7. The system of claim 1 wherein the resource hiring module recommends the candidate work location for the at least one resource based on cost and value.

8. The system of claim 1 wherein the resource hiring module provides data regarding the availability of the at least one resource at the recommended location.

9. The system of claim 1 wherein the resource hiring module provides data on the elasticity of price versus quantity and quality of the at least one resource.

10. The system of claim 1 wherein the at least one communication device is selected from a group consisting of: a cellular telephone, a smartphone, a wireless-enabled personal digital assistant, a tablet, a personal computer, a notebook and a mobile device.

11. A method for providing on-demand rate guidance for a job position in at least one geographic location utilizing an automated pay rate creation system, the method comprising the steps of:
providing a pay rate creation application installed at a processor in the automated pay rate creation system being in communication with at least one communication device via a network;
providing a messaging window on the at least one communication device for performing user interactions by a presentation module;
storing market data, client specific data and details of a plurality of job levels corresponding to the job position in a pay rate database by a database module;
enabling the user to perform a worldwide pay rate search to obtain the plurality of pay rates for the job position by a global search module;
providing a plurality of queries on the messaging window to request the plurality of job details by a request module;
receiving the plurality of job details from the request module and processing and parsing the plurality of job details into user specific configurations by a pay rate processing and parsing module;
storing the processed and parsed job details in the pay rate database by the pay rate processing and parsing module;
creating the plurality of pay rates including an average pay rate once the user confirms the plurality of job details through a pay rate creation module;
identifying the market rate and the pay rate algorithmically for each of the plurality of job details by a pay rate identification module;
performing a pay rate analysis and generating a confidence factor on the data quality based on the job position and the candidate work location by the pay rate identification module; and
recommending the candidate work location for hiring at least one resource based on the plurality of pay rates and the confidence factor by a resource hiring module;
whereby the pay rate creation module and the pay rate identification module enable the user to select at least one pay rate for the job position.

12. The method of claim 11 wherein the presentation module displays a plurality of client locations for the requested job position.

13. The method of claim 11 wherein the automated pay rate creation system enables the user to obtain details of a plurality of rate types for the job position.

14. The method of claim 14 wherein the plurality of rate types includes staffing, payroll and worker pay rate.

15. The method of claim 11 wherein the resource hiring module recommends the candidate work location for the at least one resource based on cost and value.

16. A computer program product comprising computer executable instructions embodied in a non-transitory computer readable storage medium having a computer readable program code embodied therein, the computer readable program code configured to be executed on a computer system to implement a method for providing on-demand rate guidance for a job position in at least one geographic location utilizing an automated pay rate creation system via a network, the method comprising the steps of:
providing a pay rate creation application installed at a processor in the automated pay rate creation system being in communication with at least one communication device via a network;
providing a messaging window on the at least one communication device for performing the user interactions by a presentation module;
storing market data, client specific data and details of a plurality of job levels corresponding to the job position in a pay rate database by a database module;
enabling the user to perform a worldwide pay rate search to obtain the plurality of pay rates for the job position by a global search module;
providing a plurality of queries on the messaging window to request the plurality of job details by a request module;
receiving the plurality of job details from the request module and processing and parsing the plurality of job details into user specific configurations by a pay rate processing and parsing module;
storing the processed and parsed job details in the pay rate database by the pay rate processing and parsing module;
creating the plurality of pay rates including an average pay rate once the user confirms the plurality of job details through a pay rate creation module;
identifying the market rate and the pay rate algorithmically for each of the plurality of job details by a pay rate identification module;
performing a pay rate analysis and generating a confidence factor on the data quality based on the job position and the candidate work location by the pay rate identification module; and
recommending the candidate work location for hiring at least one resource based on the plurality of pay rates and the confidence factor by a resource hiring module.

17. The computer program product of claim 16 wherein the resource hiring module recommends the candidate work location for the at least one resource based on cost and value.

18. The computer program product of claim 16 wherein the resource hiring module provides data regarding the availability of the at least one resource at the recommended location.
